(19) United States
(12) Patent Application Publication
(10) Pub. No.: US 2024/0350359 A1
(43) Pub. Date: Oct. 24, 2024

(54) Electronic device case with integrated medication container

(71) Applicant: Michael Rix, Draper, UT (US)

(72) Inventor: Michael Rix, Draper, UT (US)

(21) Appl. No.: 18/303,818

(22) Filed: Apr. 20, 2023

(51) Int. Cl. A61J 1/03; H04B 1/3888

(52) U.S. Cl. CPC A61J 1/03; H04B 1/3888

(57) ABSTRACT

The case would go on a device the user would already be carrying. Pocket size, location, purpose, and shape are not intended to be inclusive of all options and designs. Examples include but are not limited to a mobile phone, iPad, smart watch etc. This will allow the user to take anything they may require with them that would fit within the compartment and up to the user's discretion. The case can be made from any material that is considered safe to use and could have any number of ways to access the contents.

### BACKGROUND

The Electronic device case with integrated medication container (Here after known as “The case”)

A large portion of the world requires the ability to take items with them when they are not at home. This could be medication or anything a person would require taking with them. Some medication requires it to be taken at a precise time. Most people would use a device to remind them to take their medication(s) at the required time. If a device case has an integrated container that someone can put items into, it negates a possibility that it can be left at home and allows the individual to have the item when the alarm is already activated, or the need arises.

### BRIEF SUMMARY OF THE INVENTION

The case would be a device case that someone could use on their phone/iPad/watch, etc that would have an integrated pill container built into the case. There are multiple ways a pill container can be built into the case. It could be along either side, the top, bottom, back, or in a folding form (Pocket size, location, purpose, and shape are not intended to be inclusive of all options and designs). This will allow a user to carry a small amount of medication in singe form (one example is ibuprofen), or a larger medication that requires daily usage (one example is birth control medication). PLEASE NOTE Pocket size, location, purpose, and shape are not intended to be inclusive of all options and designs

### BRIEF DESCRIPTION OF THE DRAWINGS

FIG. 1 shows an example of a side pocket or compartment

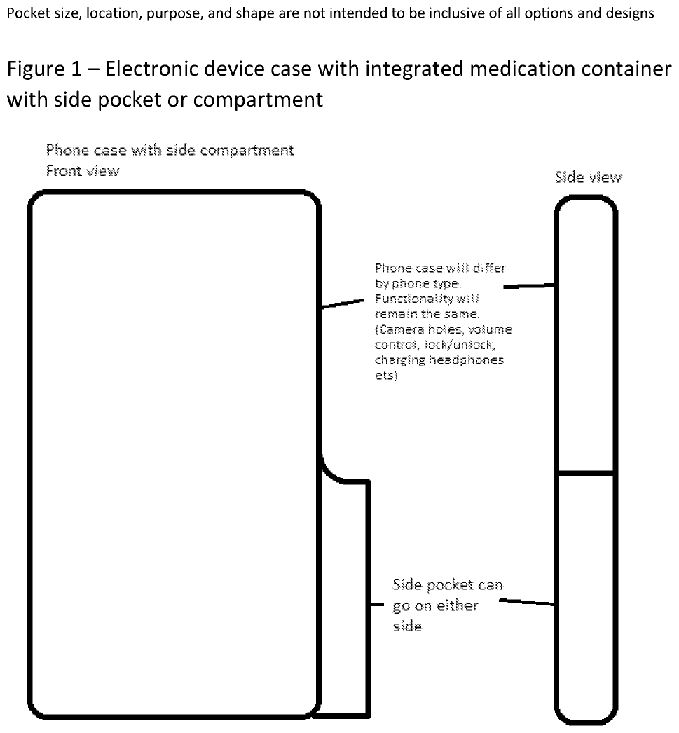

FIG. 2 shows an example of a bottom pocket or compartment

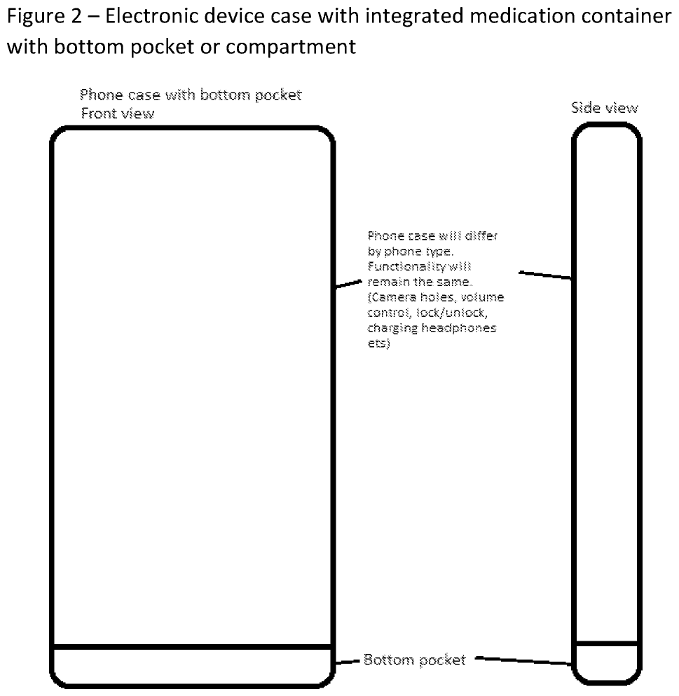

FIG. 3 shows an example of a top pocket or compartment

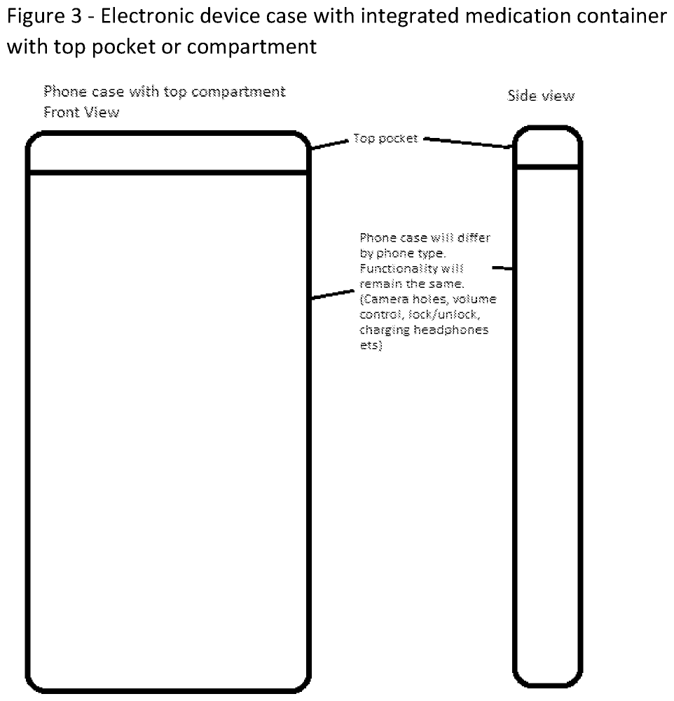

FIG. 4 shows an example of a back pocket or compartment

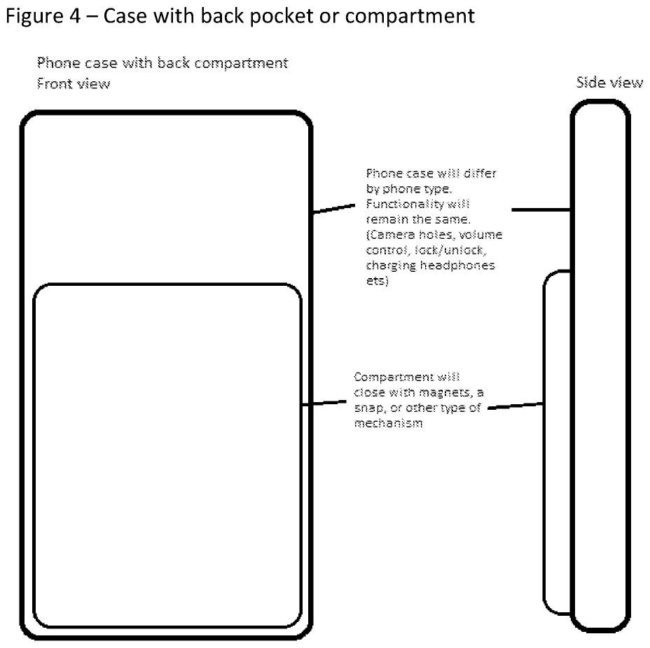

### DETAILED DESCRIPTION AND BEST MODE OF IMPLEMENTATION

The case will contain a compartment of which the pocket size, location, purpose and shape are not intended to be inclusive of all options and designs. This compartment may contain screw lids, slide on lids, magnetic connections, snap connections, zipper closure or any other type of connecting device or closure. The material could be leather, plastic, metal, or any other material that is considered safe for general use. This case may be made with any image or color that the materials or consumer may want or need. The compartment may have a “hinge” that is made of leather, plastic, or any other material that is sturdy enough to withstand usage.

1. An electronic device case with integrated medication container comprising of: a device case made from any material(s); a container integrated into the design of the device case, capable of holding solid medication for the user to be able to access medication when needed; a lid sealing the container.
